(19) United States
(12) Patent Application Publication
(10) Pub. No.: US 2026/0004622 A1
(43) Pub. Date: Jan. 1, 2026

(54) AUTHENTICATION WITH AUTHORIZATION CREDENTIAL EXCHANGE

(71) Applicant: ASSA ABLOY AB, Stockholm (SE)

(72) Inventors: Martin Kaufmann, Graz (AT); Pasquale Noce, Napoli (IT)

(21) Appl. No.: 18/867,848

(22) PCT Filed: May 23, 2022
(86) PCT No.: PCT/IT2022/000023

§ 371 Date: Nov. 21, 2024

(51) Int. Cl. G07C 9/00; H04L 9/32

(52) U.S. Cl. CPC G07C 9/00309; H04L 9/3236; H04L 9/3247; H04L 9/3263; G07C 2009/00412; G07C 2009/005

(57) ABSTRACT

Systems and methods may be used for authenticating and validating a credential for performing an action. A method may include using an access control device to exchange public keys with a user device. The method may include sending, to the user device, a first authentication cryptogram including a first signature, a public key certificate, and a Credential Trust Information (CTI), and receiving, from the user device, a second authentication cryptogram including a second signature, a public key of the user device, and a credential. The access control device may authenticate the user device based on the credential and the second signature The access control device may determine whether the credential received in the second authentication cryptogram is signed by a trusted credential issuer to validate the user device. The method may include causing the action to be performed.

### BACKGROUND

Physical control access systems may be used to restrict entry to physical spaces and permit entry to authorized individuals. For example, physical control access systems may control access to a room, a floor, a building, a safe (e.g., a floor safe, a wall safe, a freestanding safe, etc.), a cabinet, a vehicle, a case, etc. In some systems, a user device and an access control device are used, where the user device communicates with the reader (e.g., using a short distance communication technique, via wireless communication, etc.). The access control device may determine whether the user device has proper authorization or authentication to access the controlled physical area. The access control device may unlock a lock (e.g., a door lock) in response to determining that the user device includes or has provided proper authorization or authentication.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram for authentication and authorization operations in accordance with some embodiments.

FIG. 2 illustrates a system for access based on authentication and authorization of a user in accordance with some embodiments.

FIGS. 3-4 illustrate flowcharts showing techniques for authentication and authorization operations between a user device and an access control device in accordance with some embodiments.

FIGS. 5A-5B illustrate example credential data structure components in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide for authentication and authorization of a user. These systems and techniques may be used to concisely consolidate authentication and authorization messaging to grant a user access to a secured resource (e.g., by opening a door). In some examples, an asymmetric authentication (e.g., mutual authentication) may be combined with exchange of an authorization credential as part of the authentication flow. This combination may include omitting a Public Key Certificate of a user device (e.g., when the user device is in possession of the authorization credential).

In legacy systems, mutual authentication is typically performed separately from credential exchange. For example, a user or user device may be authenticated and then authorized. The combination of authentication (e.g., verifying that a user or user device is who or what they say they are) and authorization (e.g., that a user or user device is allowed to access a particular resource) provided in the systems and techniques described herein improve the technological field of security and access to secured systems. This combination allows for quicker and more secure authorization and authentication by reducing a number of interactions between devices or reducing time taken to authenticate or authorize a user or device.

An authorization credential may be used to identify an entity (e.g., a person, a car, etc.) that is permitted to perform an action (e.g., the entity is authorized to cause the action to be performed). In some examples, a prioritized list may be used for credential selection, such as when the credential is one of multiple credentials (e.g., a building access credential, a door or floor access credential, etc.).

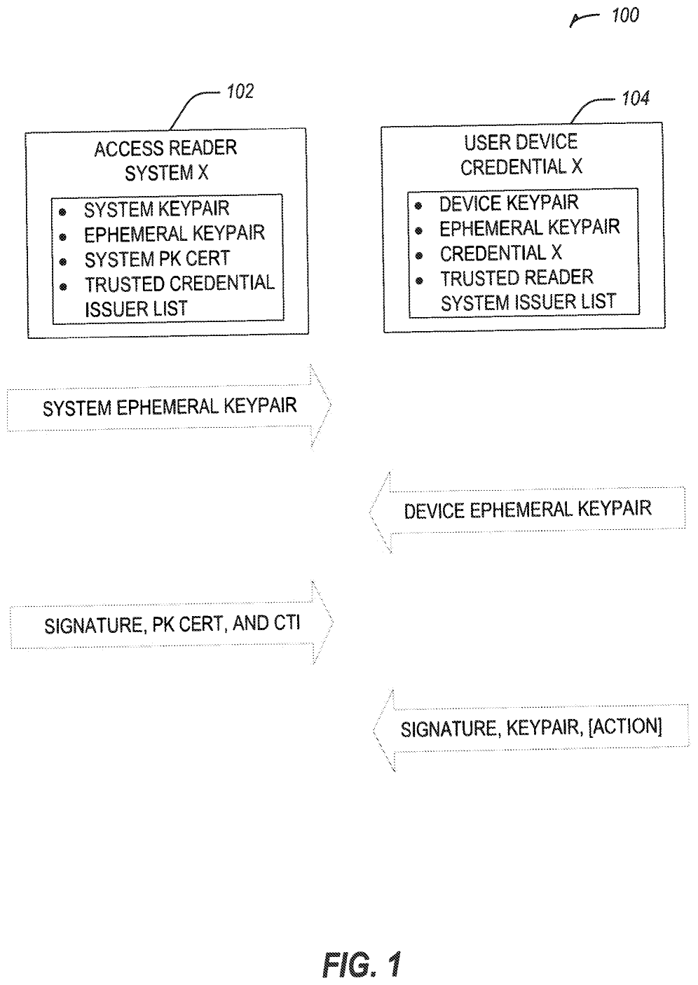

FIG. 1 illustrates a block diagram 100 for authentication and authorization operations in accordance with some embodiments. The block diagram 100 includes two devices, an access reader 102 and a user device 104. The access reader 102 and the user device 104 may communicate, such as using wireless communications, such as Wi-Fi, Bluetooth, near field communication (NFC), etc. In some examples, the access reader 102 or the user device 104 may have previously communicated (e.g., with each other or with another device) to initially establish a trust condition (e.g., register).

The access reader 102 may generate or retrieve components, before or during authentication or authorization, such as a system keypair, an ephemeral keypair, a system public key certificate, or a trusted credential issuer list. The user device 104 may generate or retrieve components, before or during authentication or authorization, such as a device keypair, an ephemeral keypair, a credential, or a trusted reader system issuer list.

FIG. 1 includes an authentication flow, which is used to prove the authenticity between both devices and may exchange a credential for an access decision. The authentication flow includes a mutual authentication between the access reader 102 and the user device 104 in two messages. Either of the two messages or both may conform with a standard, such as NIST SP800-56Ar3 “(Cofactor) Full Unified Model, C(2e, 2s, ECC CDH) Scheme” or ISO/IEC 9798-3:2019 mechanism MUT.CR. An authentication may include providing proof of possession of a secret key by adding a signature using the secret key. Proof of identity may include checking a trusted authority signature over its public key.

The access reader 102 and the user device 104 may exchange an ephemeral public key. For example, the access reader 102 may send a command with a system ephemeral public key (e.g., randomly generated at the access reader 102) and the user device 104 may send a response with a device ephemeral public key (e.g., randomly generated at the user device 104). The information exchanged may include random data embodied by either of the ephemeral public keys. The ephemeral public key (e.g., of the access reader 102 or the user device 104) may be a new asymmetric public key to add randomness to the authentication. The usage of ephemeral keys during an authentication provides perfect forward secrecy, for example.

After exchanging the ephemeral public keys, the access reader 102 and the user device 104 may perform a run time trust. The access reader 102 and the user device 104 may provide encrypted information. For example, the user device 104 may send an encrypted credential or authentication. The access reader 102 may send information in a manner that is privacy protected against eavesdropping. Privacy protection beyond eavesdropping may use a static key in some examples. Sending the information may include using an authenticated encryption (AENC) algorithm (e.g., GCM, ENC+MAC).

The access reader 102 or the user device 104 may store or access a list of trusted issuers (e.g., TIL1, TIL2), which may be used to verify the trust of the other device. The lists may be provided during registration of the access reader 102 or during credential issuance to the user device 104.

Each protected message may use symmetric session keys, which may be calculated from previously exchanged public keys, for example. The symmetric session keys may comply with a standard, such as NIST SP800-56Cr2. A final session key may be calculated from exchanged public keys (which may include both ephemeral and both static keys, in some examples).

The signatures of the messages sent between the access reader 102 and the user device 104 may be calculated over both ephemeral public keys and a credential trust information (CTI). The signatures may be used for the authentication, and they may protect against key compromise impersonation (KCI) attacks. Calculating the signatures using only a device's own ephemeral public key may make some attacks possible (e.g., replay attack). Adding the CTI protects against a possible manipulation.

The user device 104 message may include an optional action, which allows an end-user to specify a non-default action (e.g., “lock”, “unlock”, “open”, etc., such as for a door, a safe, a building, a window, or the like). A default action may be pre-registered (e.g., to the access reader 102, to the user device 104, to the resource accessed, etc.) and executed after authentication and authorization of the user device 104 has been completed by the access reader 102.

The message sent by the access reader 102 after receiving the device ephemeral public key may be a first authentication cryptogram, which may include a signature and a public key certificate. The signature and the public key certificate (PKCert1) may be used for authentication by the access reader 102. The first authentication cryptogram may include a CTI, which may be used to request a suitable credential. The CTI may include a prioritized list of hashes of trusted credential issuer public keys. The user device 104 may consult a list to identify a first matching hash to select as a credential.

The user device 104 may validate whether the PKCert1 was signed by a trusted reader system issuer key. After validation and selection of a credential by the user device 104, a message may be generated including a second authentication cryptogram. The second authentication cryptogram may include a first part including a signature and a public key of the user device 104. The second authentication cryptogram may include a second part including the credential (CredX) and optionally an action. For security reason, the credential CredX may include the hash of the device public key to bind the credential to the user device 104.

In some examples, a CTIMatch may be included in the second authentication cryptogram, conditional on whether the CTI contained more than one hash. The CTIMatch may include the hash of the matching credential. The Signature and the CredX in the second authentication cryptogram may be used by the access reader 102 for authentication of the user device 102. For the authentication, the access reader 102 may validate whether the public key in the first authentication cryptogram matches with the one in the CertX in the second authentication cryptogram. In some examples, the first and second authentication cryptogram may have different encryption. For example, the second authentication cryptogram may use the final session keys, while the first authentication cryptogram does not have access to the final session keys. The access reader may validate whether the CertX is signed by a trusted credential issuer key.

Table 1 below provides example calculation details of the mutual authentication flow between the access reader 102 and the user device 104.

TABLE 1

| Access Reader 102 | User Device 104 |
|---|---|
| Part 1 | |
| 1) Generate ephemeral key pair | |
| K_{eI} = (SK_{eI}, PK_{eI}) | |
| 2) General Authenticate: PK_{eI}, send | 3) Generate ephemeral key pair |
| | K_{eR} = (SK_{eR}, PK_{eR}) |
| 5) I_{eI} = PK_{eI}.x[0:8] | 4) send PK_{eR} |
| 6) I_{eR} = PK_{eR}.x[0:8] | |
| Part 2 | |
| 7) Sig_{I} = Sign(SK_{I}, 1 ∥ PK_{eI} ∥ PK_{eR} ∥ CTI) | |
| 8) Generate symmetric keys K0_{ENC} | |
| and K0_{MAC} | |
| 8a) Zₑ = ECDH(PK_{eR}, SK_{eI}) | |
| 8b) K0_{DK} = CMAC(0-V, Zₑ) | |
| 8c) K0_{ENC} = CMAC(K0_{DK}, | |
| Label(‘00’) ∥ ‘00’ ∥ ‘0080’ ∥ ‘01’ ∥ | |
| Diversifier ∥ AlgoID_asym ∥ | |
| AlgoID_sym ∥ Keyset ∥ I_{eI} ∥ I_{eR}) | |
| 8d) K0_{MAC} = CMAC(K0_{DK}, | |
| Label(‘02’) ∥ ‘00’ ∥ ‘0080’ ∥ ‘01’ ∥ | |
| Diversifier ∥ AlgoID_asym ∥ | |
| AlgoID_sym ∥ Keyset ∥ I_{eI} ∥ I_{eR}) | |
| 9) ENC_{I} = ENC_{CBC}(K0_{ENC}, Sig_{I} ∥ | |
| PKCert_{I} ∥ CTI) | |
| using IV = ENC(K0_{MAC}, PK_{eI}.x[0:16]) | |
| 10) MAC_{I} = CMAC(K0_{MAC}, ENC_{I}) | |
| 11) send ENC_{I} ∥ MAC_{I} | 12) I_{eI} = PK_{eI}.x[0:8] |
| | 13) I_{eR} = PK_{eR}.x[0:8] |
| | 14) Generate symmetric keys K0_{ENC} |
| | and K0_{MAC} |
| | 14a) Zₑ = ECDH(PK_{eI}, SK_{eR}) |
| | 14b) K0_{DK} = CMAC(0-V, Zₑ) |
| | 14c) K0_{ENC} = CMAC(K0_{DK}, |
| | Label(‘00’) ∥ ‘00’ ∥ ‘0080’ ∥ ‘01’ ∥ |
| | Diversifier ∥ AlgoID_asym ∥ |
| | AlgoID_sym ∥ Keyset ∥ I_{eI} ∥ I_{eR}) |
| | 14d) K0_{MAC} = CMAC(K0_{DK}, |
| | Label(‘02’) ∥ ‘00’ ∥ ‘0080’ ∥ ‘01’ ∥ |
| | Diversifier ∥ AlgoID_asym ∥ |
| | AlgoID_sym ∥ Keyset ∥ I_{eI} ∥ I_{eR}) |
| | 15) Sig_{I} ∥ PKCert_{I} = DEC_{CBC}(K0_{ENC}, |
| | ENC_{I}) |
| | using IV = ENC(K0_{MAC}, PK_{eI}.x[0:16]) |
| | 16) I_{I} = PK_{I}.x[0:8] |
| | 17) Sig_{R} = Sign(SK_{R}, 2 ∥ PK_{eI} ∥ PK_{eR} ∥ CTI) |
| | 18) Generate symmetric keys K1_{ENC} |
| | and K1_{MAC} |
| | 18a) Z₁ = ECDH(PK_{I}, SK_{eR}) |
| | 18b) K1_{DK} = CMAC(0-V, Zₑ ∥ Z_{I}) |
| | 18c) K1_{ENC} = CMAC(K1_{DK}, |
| | Label(‘01’) ∥ ‘00’ ∥ ‘0080’ ∥ ‘01’ ∥ |
| | Diversifier ∥ AlgoID_asym ∥ |
| | AlgoID_sym ∥ Keyset ∥ I_{I} ∥ I_{eI} ∥ I_{eR}) |
| | 18d) K1_{MAC} = CMAC(K1_{DK}, |
| | Label(‘03’) ∥ ‘00’ ∥ ‘0080’ ∥ ‘01’ ∥ |
| | Diversifier ∥ AlgoID_asym ∥ |
| | AlgoID_sym ∥ Keyset ∥ I_{I} ∥ I_{eI} ∥ I_{eR}) |
| | 19) ENC_{R1} = ENC_{CBC}(K1_{ENC}, Sig_{R} ∥ |
| | PKCert_{R} ∥ SI ∥ [CTIMatch]) |
| | using IV = ENC(K1_{MAC}, PK_{eR}.x[0:16]) |
| | 20) MAC_{R1} = CMAC(K1_{MAC}, ENC_{R1}) |
| | 21) I_{R} = PK_{R}.X[0:8] |
| | 22) Generate symmetric session keys |
| | 22a) Z_{S} = ECDH(PK_{I}, SK_{R}) |
| | 22b) Ks_{DK} = CMAC(0-V, Zₑ ∥ Z_{S}) |
| | 22c) Ks_{ENC} = CMAC(Ks_{DK}, |
| | Label(‘04’) ∥ ‘00’ ∥ ‘0080’ ∥ ‘01’ ∥ |
| | Diversifier ∥ AlgoID_asym ∥ |
| | AlgoID_sym ∥ Keyset ∥ I_{I} ∥ I_{R} ∥ I_{eI} ∥ I_{eR}) |
| | 22d) Ks_{MAC} = CMAC(Ks_{DK}, |
| | Label(‘06’) ∥ ‘00’ ∥ ‘0080’ ∥ ‘01’ ∥ |
| | Diversifier ∥ AlgoID_asym ∥ |
| | AlgoID_sym ∥ Keyset ∥ I_{I} ∥ I_{R} ∥ I_{eI} ∥ I_{eR}) |
| | 23) ENC_{R2} = ENC_{CBC}(Ks_{ENC}, |
| | Credential ∥ [Action]) |
| | using IV = R-IV |
| | 24) MAC_{R2} = CMAC(Ks_{MAC}, ENC_{R2}) |
| 26) I_{I} = PK_{I}.x[0:8] | 25) send ENC_{R1} ∥ MAC_{R1} ∥ ENC_{R2} ∥ MAC_{R2} |
| 27) Generate symmetric keys K1_{ENC} | |
| and K1_{MAC} | |
| 27a) Z_{I} = ECDH(PK_{eR}, SK_{I}) | |
| 27b) K1_{DK} = CMAC(0-V, Zₑ ∥ Z_{I}) | |
| 27c) K1_{ENC} = CMAC(K1_{DK}, | |
| Label(‘01’) ∥ ‘00’ ∥ ‘0080’ ∥ ‘01’ ∥ | |
| Diversifier ∥ AlgoID_asym ∥ | |
| AlgoID_sym ∥ Keyset ∥ I_{I} ∥ I_{eI} ∥ I_{eR}) | |
| 27d) K1_{MAC} = CMAC(K1_{DK}, | |
| Label(‘03’) ∥ ‘00’ ∥ ‘0080’ ∥ ‘01’ ∥ | |
| Diversifier ∥ AlgoID_asym ∥ | |
| AlgoID_sym ∥ Keyset ∥ I_{I} ∥ I_{eI} ∥ I_{eR}) | |
| 28) Sig_{R} ∥ PKCert_{R} ∥ SI ∥ | |
| [CTIMatch] = DEC_{CBC}(K1_{ENC}, ENC_{R1}) | |
| using IV = ENC(K1_{MAC}, PK_{eR}.x[0:16]) | |
| 29) I_{R} = PK_{R}.x[0:8] | |
| 30) Generate symmetric session keys | |
| 31a) Z_{S} = ECDH(PK_{R}, SK_{I}) | |
| 31b) Ks_{DK} = CMAC(0-V, Zₑ ∥ Z_{S}) | |
| 31c) Ks_{ENC} = CMAC(Ks_{DK}, | |
| Label(‘04’) ∥ ‘00’ ∥ ‘0080’ ∥ ‘01’ ∥ | |
| Diversifier ∥ AlgoID_asym ∥ | |
| AlgoID_sym ∥ Keyset ∥ I_{I} ∥ I_{R} ∥ I_{eI} ∥ I_{eR}) | |
| 31d) Ks_{MAC} = CMAC(Ks_{DK}, | |
| Label(‘06’) ∥ ‘00’ ∥ ‘0080’ ∥ ‘01’ ∥ | |
| Diversifier ∥ AlgoID_asym ∥ | |
| AlgoID_sym ∥ Keyset ∥ I_{I} ∥ I_{R} ∥ I_{eI} ∥ I_{eR}) | |
| 32) Credential ∥ [Action] = | |
| DEC_{CBC}(Ks_{ENC}, ENC_{R2}) | |
| using IV = R-IV | |

In Table 1, “e” means ephemeral “I” is an initiator, in this case the access reader 102, “R” is a responder, in this case the user device 104, “s” is a session, “PK” is a public key of an asymmetric keypair, “SK” is a secret key of an asymmetric keypair (e.g., a private key), and “x” is an x-coordinate.

Table 1 includes information defined as including bits that are numbered right to left from 1 to 8, where for example b1 is the rightmost bit (e.g., least significant bit) and bS is the leftmost bit (e.g., most significant bit) in a byte, “A∥B,” where the ‘∥’ operator denotes the concatenation of the two bit or byte strings A and B in the order specified, “hex” digits appearing between apostrophes are hexadecimal (base 16) digits, “A[from:to]” which indicates a byte substring of the byte string A, taken from byte position “from” (counted from left to right, starting with 0) up to but not including position “to,” “A(x)” which indicates that byte string A includes x bytes, “0-V” which is a zero vector or byte string with all zeros, and “Ix” which is a keypair identifier of a key including a first 8 bytes (leftmost 64 bits) of the x coordinate of the public key PKx of given key pair x.

Table 1 includes acronyms and abbreviations, such as PKCertA, a Public Key Certificate of Endpoint A, Cert (K, data), a certificate over data using key secret key K for signature creation, ENC (K, data), encrypting data with key K in ECB mode, DEC (K, data), decrypting data with key K in ECB mode, ENCCBC (K, data), encrypting data with key K in CBC mode, DECCBC (K, data), decrypting data with key K in CBC mode, CMAC (K, data), CMAC over data with key K, SHA256 (data), SHA-256 over data, ECDH (SK, PK), Elliptic Curve Diffie Heliman operation using secret key (SK) and public key (PK), Sign (SK, data), signing the data using the Secret Key (SK) (where signing includes calculating first a hash over the data and then calculating the signature), CMAC, Cipher-Based Message Authentication Code, CTI, Credential Trust Information, EC, Encryption Counter, ENC, encryption, ID, identification, IV, initialization vector, and MAC, Message Authentication Code.

For security reason the authentication flow may be implemented in a time invariant manner. For example, if anything goes wrong during the flow, each next operation may be performed, but by returning randomized data, for example. Using randomized data protects the system from attacks because the credential is only returned correctly if the flow is successful and the access reader 102 and the user device 104 are authenticated. This provides further security because an attacker does not know which step caused the error.

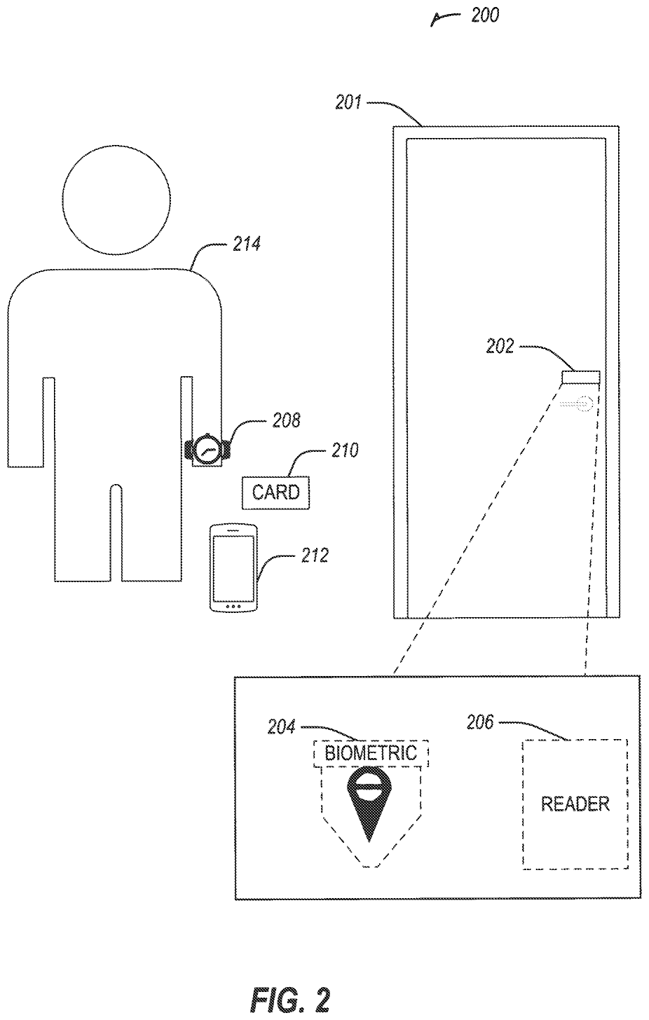

FIG. 2 illustrates an access control system 200 for access based on authentication and authorization of a user in accordance with some embodiments. The access control system 200 includes an access control device 202, which controls access to a secure resource (e.g., by controlling whether a door 201 is locked or open). The access control device 202 may include a reader, such as a reader 206 or a biometric reader 204, in some examples. The access control device 202 may communicate with a user device (e.g., one or more of a smart device 208, a card 210, such as a digital card with passive communication circuitry such as NFC, or other communication circuitry, a mobile device 212, etc.) of a user 214.

The access control system 200 may include components needed to provide access and operate locking mechanisms, in some examples. The access control device 202 may include the access reader 206 to read a credential from a user device (e.g., 208, 210, 212), or send credential information to an access controller (e.g., operated on a remote server). A user device (e.g., 208, 210, 212) may include a portable device with one or more credentials.

In some examples, authorization includes a process of verifying that a credential holder has permission to perform a requested or default operation (e.g., unlocking a door). A credential may include a logical entity that allows for identification of the credential holder. The credential holder may include an entity (e.g., a person) that is given a credential, for example embodied in a device (e.g., 208, 210, 212, etc.). The credential may be issued by a trusted entity or authority. A trusted entity or authority may include an entity that is trusted by (e.g., the access reader 206, a user device 208, 210, 212, etc., or the like).

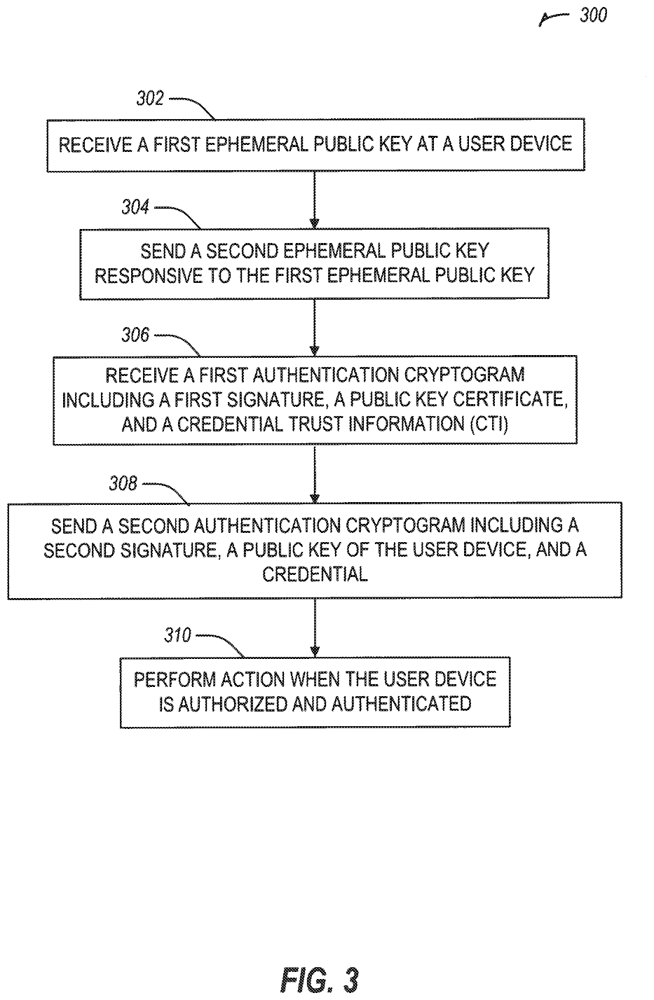

FIG. 3 illustrates a flowchart showing a technique 300 for authentication and authorization operations related to a user device in accordance with some embodiments. In an example, operations of the technique 300 may be performed by processing circuitry, for example by executing instructions stored in memory. The processing circuitry may include a processor, a system on a chip, or other circuitry (e.g., wiring). For example, technique 300 may be performed by processing circuitry of a device (or one or more hardware or software components thereof), such as those illustrated and described with reference to FIG. 2. The device may be an access control device, such as a device controlling access to a physical space or a user device such as a phone.

The technique 300 includes an operation 302 to receive a first ephemeral public key at a user device. The first ephemeral public key may be randomly generated, for example by an access control device.

The technique 300 includes an operation 304 to send a second ephemeral public key responsive to the first ephemeral public key. The second ephemeral public key may be randomly generated, for example by the user device.

The technique 300 includes an operation 306 to receive a first authentication cryptogram including a first signature, a public key certificate, and a Credential Trust Information (CTI). In some examples, operation 306 may include sending the first authentication cryptogram using an authenticated encryption (AENC) algorithm (e.g., Galois/Counter Mode (GCM), encrypt then message authentication code (MAC), or the like). The first signature may be generated using a device key of the access control device.

The technique 300 includes an operation 308 to send a second authentication cryptogram including a second signature (optionally), a public key of the user device, and a credential. The credential may include a hash of the public key of the user device to bind the credential to the user device. In some examples, the second authentication cryptogram uses a different encryption than the first authentication cryptogram. For example, the second authentication cryptogram may use an encryption based on final session keys. In some examples, the CTI includes a sorted list with a plurality of hashes. In this example, the credential may be a first hash from a user device list of hashes that matches a hash of the sorted list. In some versions of technique 300, operation 308 may include omitting the second signature. In these examples, the second signature may be omitted, and instead rely on the encryption of the credential in the second authentication cryptogram with the final session key, which provides an implicit authentication. In versions of the technique 300 where operation 308 includes the second signature, the second signature and the encryption of the credential with the final session key may both be used to provide security.

The technique 300 includes an operation 310 to perform an action when the user device is authorized and authenticated. The action may be a default action, or the action may be specified in the second authentication cryptogram (e.g., to override the default action). The action may include permitting a user to access a secure resource, such as by opening a door, a safe, a building, etc.

In an example, one or both of the ephemeral keys may also be pre-computed to increase performance or speed during the authentication. When an access reader privacy protection is not required, the encryption in operation 306 may be omitted, and in some examples, an integrity protection may be used. In operation 306, in some examples, the CTI my be removed from the signature. In this example, there may be no proof of whether the correct CTI arrived at the user device, but the interaction may be quicker.

In some examples, instead of a mutual authentication (e.g., operations 302 and 304), a fast bilateral key may be used. The technique 300 may include using a confirmation algorithm. This algorithm may omit some scalar multiplications at the cost of security. For example, the algorithm may be quicker but not allow for perfect forward secrecy or some privacy protection.

In some examples, the first signature of operation 306 may be omitted. In these example, an authenticity check of the access reader may not be done during the technique 300. Instead, a subsequent use of secure messaging may be used to prove the authenticity. In these examples, there is a risk that the credential may be sent to a non-authenticated device in some circumstances. By removing the first signature, the flow may become vulnerable against key compromise impersonation (K-CI) attacks. This risk may be mitigated by using a secure Diffie-Hellman protocol such as a Menezes-Qu-Vanstone protocol (MQV) or a hash variant (HMQV) instead of elliptic-curve Diffie-Hellman (ECCDH) for shared secret calculation (Z) to protect against K-CI attacks. In some examples, a symmetric Galois/Counter Mode (GCM) cryptographic mode may be used instead of Cipher block chaining (CBC) or Cipher-based message authentication code (CMAC), however not all devices may support this crypto mode.

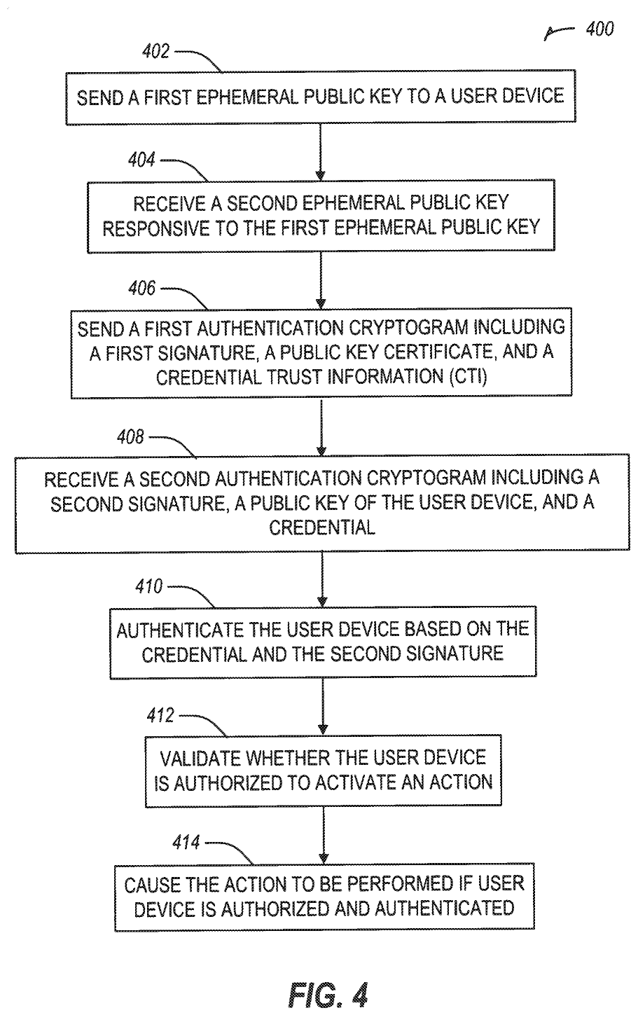

FIG. 4 illustrates a flowchart showing a technique 400 for authentication and authorization operations at an access control device in accordance with some embodiments. In an example, operations of the technique 400 may be performed by processing circuitry, for example by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 2. The device may be an access control device, such as a device controlling access to a physical space or a user device such as a phone.

The technique 400 includes an operation 402 to send, for example from an access control device, a first ephemeral public key to a user device. The first ephemeral public key may be randomly generated (e.g., by the access control device). The technique 400 includes an operation 404 to receive, for example from the user device, a second ephemeral public key responsive to the first ephemeral public key.

The technique 400 includes an operation 406 to send, for example to the user device, a first authentication cryptogram including a first signature, a public key certificate, and a Credential Trust Information (CTI). In some examples, operation 406 may include sending the first authentication cryptogram using an authenticated encryption (AENC) algorithm (e.g., Galois/Counter Mode (GCM), encrypt then message authentication code (MAC), or the like). The first signature may be generated using a device key of the access control device. The first signature may be used to sign the CTI, the first ephemeral public key, the second ephemeral public key, or the like.

The technique 400 includes an operation 408 to receive, for example from the user device, a second authentication cryptogram including a second signature, a public key of the user device, and a credential. The credential may include a hash of the public key of the user device to bind the credential to the user device. In some examples, the second authentication cryptogram uses a different encryption than the first authentication cryptogram. For example, the second authentication cryptogram may use an encryption based on final session keys. In some examples, the CTI includes a sorted list with a plurality of hashes. In this example, the credential may be a first hash from a user device list of hashes that matches a hash of the sorted list. The second signature may be used to sign the CTI, the first ephemeral public key, the second ephemeral public key, or the like. In some versions of technique 400, operation 408 may include omitting the second signature. In these examples, the second signature may be omitted, and instead rely on the encryption of the credential in the second authentication cryptogram with the final session key, which provides an implicit authentication. In versions of the technique 400 where operation 408 includes the second signature, the second signature and the encryption of the credential with the final session key may both be used to provide security.

The technique 400 includes an operation 410 to authenticate the user device based on the credential and the second signature.

The technique 400 includes an operation 412 to validate whether the user device is authorized to activate an action based on a determination of whether the credential received in the second authentication cryptogram is signed by a trusted credential issuer. The determination may include a verification that the trusted credential issuer is in a stored list of trusted issuers, the list generated during a prior registration. In some examples, the second authentication cryptogram may indicate the action, for example to replace a default action. The action may include permitting a user to access a secure resource, such as by opening a door, a safe, a building, etc.

The technique 400 includes an operation 414 to cause, in response to validating that the user device is authorized to activate the action and that the user device is authenticated, the action to be performed. The technique may include performing each operation other than causing the action to be performed, regardless of whether a failure occurred at any previous operation. This may be useful to prevent an unauthorized user from knowing where a failure to authenticate occurred.

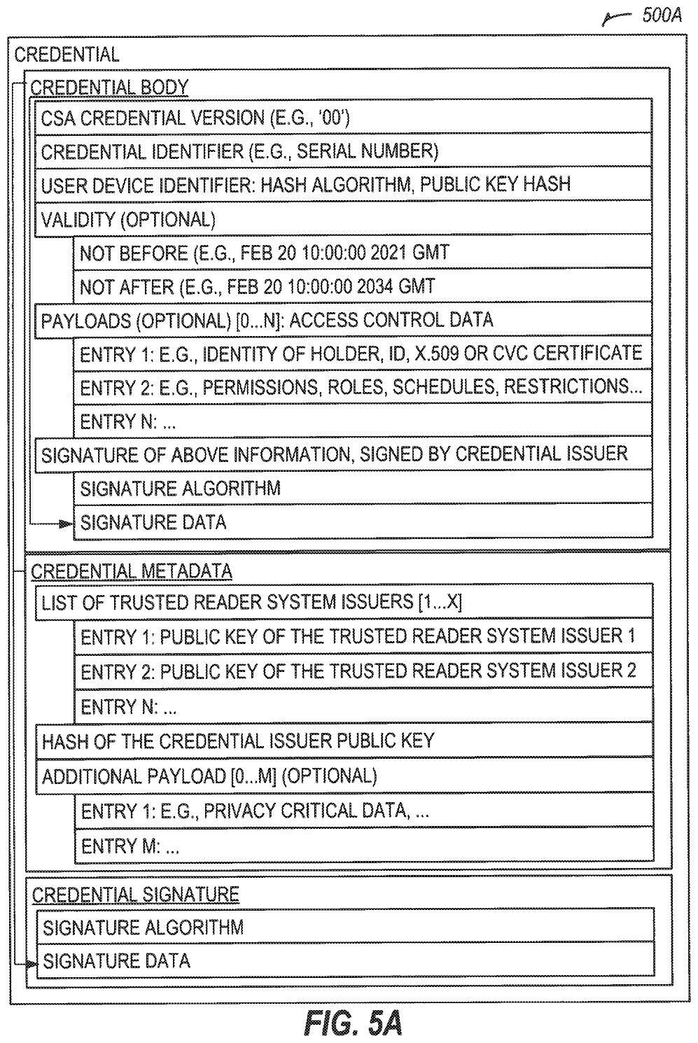

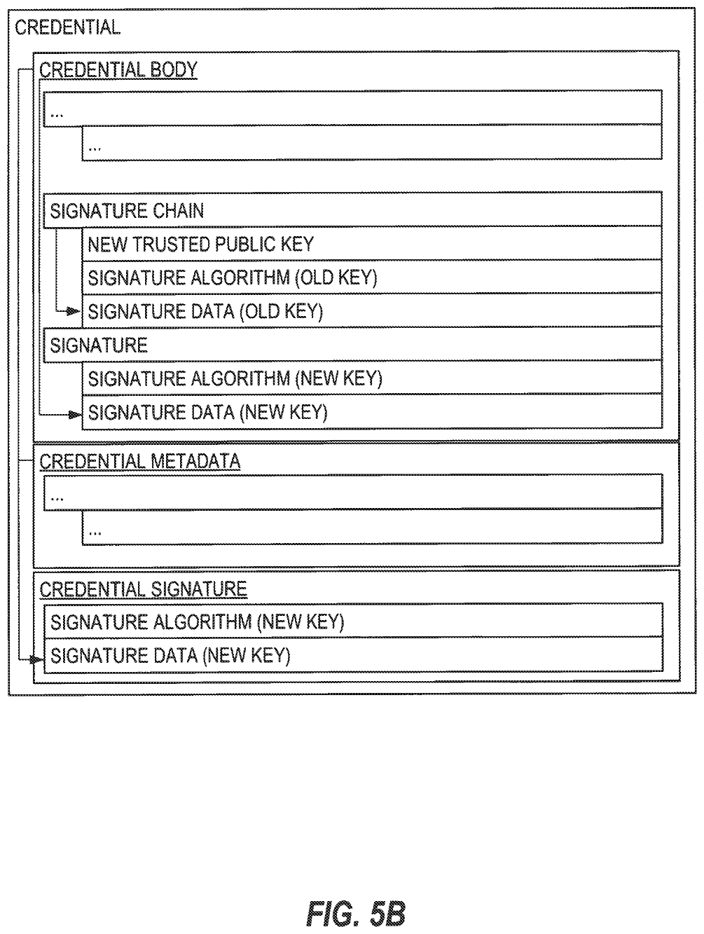

FIGS. 5A-5B illustrate example credential data structure components in accordance with some embodiments. A credential data structure 500 of FIG. 5A includes a credential body, credential metadata and a credential signature. The credential signature may be used to sign the credential, as described above. For example, the credential body may be signed by an access solution, such as including a binding to a user device (e.g., that generates, sends, or receives the credential). The signing may be used to prove what entity has issued the credential or what user device is assigned to the credential. The credential may include a list of trusted reader system issuers, which may be used to determine which particular access reader or set of access readers are to be trusted.

The credential body is the part of the credential that the user device transmits to the access reader during the authentication. The credential body may be separately signed to protect it from tampering during transit. The credential body may include a credential identifier, which may be unique within an access control system. The credential identifier may include information that makes selection easier in cases where multiple credentials match a selection request. The credential body may include a list of payloads. Payload format is not specified and may follow any standard, to allow interoperability with existing and future standards and infrastructure. In an example use-case, a payload may not be needed, as the public key or credential identifier may be used to authenticate the user. In another example use-case, multiple payloads may be provided in the credential, for example where one is an offline payload opening interior doors and one is an end-to-end encrypted user identifier used by an online turn-style entrance door. The credential body may include a minimum amount of information required for an access decision (e.g., it may avoid using personal information, which may be a privacy problem, or may be used to track the credential holder).

The credential may include credential metadata, which may be used only on the user device, in some examples. The list of trusted reader system issuers in the credential metadata may be used to verify access reader trust during the authentication. For example, if the access reader system sends a public key that is not in the list of trusted reader system issuers, the access reader system may not be trusted by the user device (or may be disregarded, in examples where the user device unintentionally triggers a proximity authentication). The optional additional payload of the credential metadata may be used to hold additional information that is not to be (and is not) shared with the access reader during the transaction or authentication. This information may include personal information about the credential holder. The optional additional payload may be used to hold additional information about whether a user authentication is required on the user device, in some examples.

The credential may include a credential signature that may be used to protect the credential during issuance. The credential encoding may be size optimized. In the example of FIG. 5A, a single credential signature algorithm and signature data are shown. FIG. 5B illustrates a more complex embodiment, which may include any one or more of the components of FIG. 5A. For example, a credential data structure 500B of FIG. 5B includes a credential body, credential metadata and a credential signature. The credential may support signature chaining. For example, when an access control system add a new trusted credential issuer (and optionally, an access reader may not be updated), the new trust may be supported by chaining the signature in the credential. The credential data structure 500B illustrates an example of a signature chain, where the new trusted public key, the signature algorithm and signature data of the old key, and the chain indicating arrow represent the signature chaining. In this example, a new signature algorithm and data (e.g., with a new key) may be used, along with the stored old key signature algorithm and data to keep the chain and the improved security of the new key technique. When the signature algorithm does not include a random number in its calculation, the signature algorithm structure may be extended to hold a nonce (or random number) in some examples.

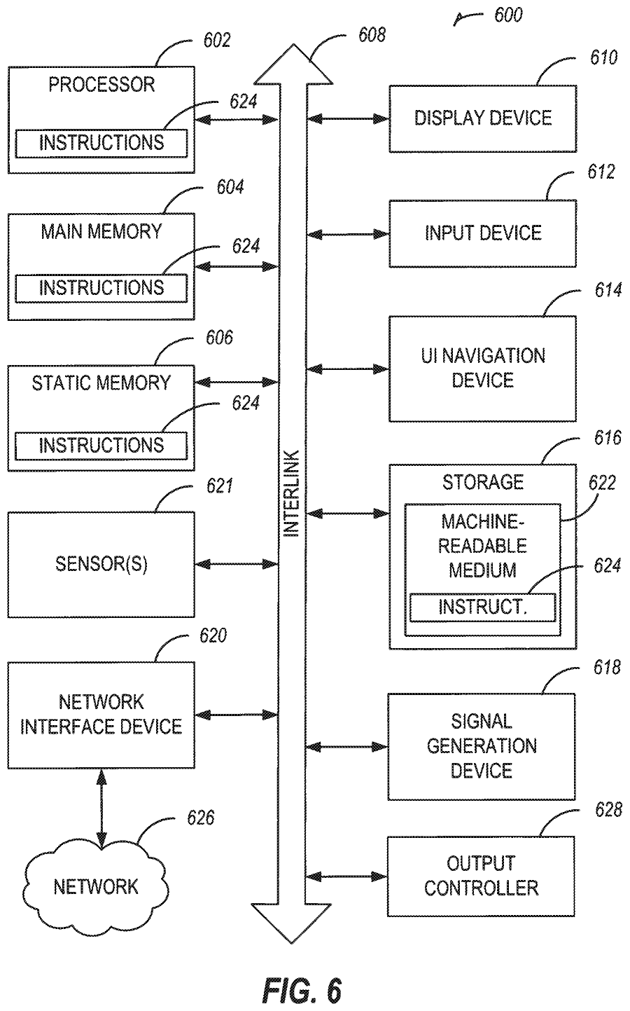

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi-®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

Example 1 is a method performed at an access control device comprising: sending, from the access control device, a first ephemeral public key to a user device; receiving, from the user device, a second ephemeral public key responsive to the first ephemeral public key; sending, to the user device, a first authentication cryptogram including a first signature, a public key certificate, and a Credential Trust Information (CTI); receiving, from the user device, a second authentication cryptogram including a second signature, a public key of the user device, and a credential; authenticating the user device based on the credential and the second signature; validating whether the user device is authorized to activate an action based on a determination of whether the credential received in the second authentication cryptogram is signed by a trusted credential issuer; and causing, in response to validating that the user device is authorized to activate the action and that the user device is authenticated, the action to be performed.

In Example 2, the subject matter of Example 1 includes, wherein the first ephemeral public key is randomly generated by the access control device.

In Example 3, the subject matter of Examples 1-2 includes, wherein sending the first authentication cryptogram includes sending the first authentication cryptogram using an authenticated encryption (AENC) algorithm.

In Example 4, the subject matter of Examples 1-3 includes, wherein the determination includes a verification that the trusted credential issuer is in a stored list of trusted issuers, the list generated during a prior registration.

In Example 5, the subject matter of Examples 1-4 includes, wherein the first signature is generated using a device key of the access control device.

In Example 6, the subject matter of Examples 1-5 includes, wherein the second authentication cryptogram indicates the action, which replaces a default action.

In Example 7, the subject matter of Examples 1-6 includes, wherein the action includes opening a door.

In Example 8, the subject matter of Examples 1-7 includes, wherein the credential includes a hash of the public key of the user device to bind the credential to the user device.

In Example 9, the subject matter of Examples 1-8 includes, wherein the CTI includes a sorted list with a plurality of hashes, and wherein the credential is a first hash from a user device list of hashes that matches a hash of the sorted list.

In Example 10, the subject matter of Examples 1-9 includes, wherein the second authentication cryptogram uses a different encryption than the first authentication cryptogram, the second authentication cryptogram using an encryption based on final session keys.

In Example 11, the subject matter of Examples 1-10 includes, wherein each operation, other than causing the action to be performed, occurs regardless of whether a failure occurred at any previous operation.

Example 12 is at least one machine-readable medium including instructions, which when executed by processing circuitry of an access control device, cause the access control device to: send a first ephemeral public key to a user device; receive, from the user device, a second ephemeral public key responsive to the first ephemeral public key; send, to the user device, a first authentication cryptogram including a first signature, a public key certificate, and a Credential Trust Information (CTI); receive, from the user device, a second authentication cryptogram including a second signature, a public key of the user device, and a credential; authenticate the user device based on the credential and the second signature; validate whether the user device is authorized to activate an action based on a determination of whether the credential received in the second authentication cryptogram is signed by a trusted credential issuer; and cause, in response to validating that the user device is authorized to activate the action and that the user device is authenticated, the action to be performed.

In Example 13, the subject matter of Example 12 includes, wherein the first ephemeral public key is randomly generated at the access control device.

In Example 14, the subject matter of Examples 12-13 includes, wherein to send the first authentication cryptogram, the instructions are further to cause the access control device to send the first authentication cryptogram using an authenticated encryption (AENC) algorithm.

In Example 15, the subject matter of Examples 12-14 includes, wherein the determination includes a verification that the trusted credential issuer is in a stored list of trusted issuers, the list generated during a prior registration.

In Example 16, the subject matter of Examples 12-15 includes, wherein the first signature is generated using a device key of the access control device.

In Example 17, the subject matter of Examples 12-16 includes, wherein the second authentication cryptogram indicates the action, which replaces a default action.

In Example 18, the subject matter of Examples 12-17 includes, wherein the action includes opening a door.

Example 19 is an access control device comprising: processing circuitry; and memory, including instructions, which when executed by the processing circuitry, cause the processing circuitry to: send a first ephemeral public key to a user device; receive, from the user device, a second ephemeral public key responsive to the first ephemeral public key; send, to the user device, a first authentication cryptogram including a first signature, a public key certificate, and a Credential Trust Information (CTI); receive, from the user device, a second authentication cryptogram including a second signature, a public key of the user device, and a credential; authenticate the user device based on the credential and the second signature; validate whether the user device is authorized to activate an action based on a determination of whether the credential received in the second authentication cryptogram is signed by a trusted credential issuer; and cause, in response to validating that the user device is authorized to activate the action and that the user device is authenticated, the action to be performed.

In Example 20, the subject matter of Example 19 includes, wherein the CTI includes a sorted list with a plurality of hashes, and wherein the credential is a first hash from a user device list of hashes that matches a hash of the sorted list.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method performed at an access control device comprising:
sending, from the access control device, a first ephemeral public key to a user device;
receiving, from the user device, a second ephemeral public key responsive to the first ephemeral public key;
sending, to the user device, a first authentication cryptogram including a first signature, a public key certificate, and a Credential Trust Information (CTI);
receiving, from the user device, a second authentication cryptogram including a second signature, a public key of the user device, and a credential;
authenticating the user device based on the credential and the second signature;
validating whether the user device is authorized to activate an action based on a determination of whether the credential received in the second authentication cryptogram is signed by a trusted credential issuer; and
causing, in response to validating that the user device is authorized to activate the action and that the user device is authenticated, the action to be performed.

2. The method of claim 1, wherein the first ephemeral public key is randomly generated by the access control device.

3. The method of claim 1, wherein sending the first authentication cryptogram includes sending the first authentication cryptogram using an authenticated encryption (AENC) algorithm.

4. The method of claim 1, wherein the determination includes a verification that the trusted credential issuer is in a stored list of trusted issuers, the list generated during a prior registration.

5. The method of claim 1, wherein the first signature is generated using a device key of the access control device.

6. The method of claim 1, wherein the second authentication cryptogram indicates the action, which replaces a default action.

7. The method of claim 1, wherein the action includes opening a door.

8. The method of claim 1, wherein the credential includes a hash of the public key of the user device to bind the credential to the user device.

9. The method of claim 1, wherein the CTI includes a sorted list with a plurality of hashes, and wherein the credential is a first hash from a user device list of hashes that matches a hash of the sorted list.

10. The method of claim 1, wherein the second authentication cryptogram uses a different encryption than the first authentication cryptogram, the second authentication cryptogram using an encryption based on final session keys.

11. The method of claim 1, wherein each operation, other than causing the action to be performed, occurs regardless of whether a failure occurred at any previous operation.

12. At least one machine-readable medium including instructions, which when executed by processing circuitry of an access control device, cause the access control device to:
send a first ephemeral public key to a user device;
receive, from the user device, a second ephemeral public key responsive to the first ephemeral public key;
send, to the user device, a first authentication cryptogram including a first signature, a public key certificate, and a Credential Trust Information (CTI);
receive, from the user device, a second authentication cryptogram including a second signature, a public key of the user device, and a credential;
authenticate the user device based on the credential and the second signature;
validate whether the user device is authorized to activate an action based on a determination of whether the credential received in the second authentication cryptogram is signed by a trusted credential issuer; and
cause, in response to validating that the user device is authorized to activate the action and that the user device is authenticated, the action to be performed.

13. The at least one machine-readable medium of claim 12, wherein the first ephemeral public key is randomly generated at the access control device.

14. The at least one machine-readable medium of claim 12, wherein to send the first authentication cryptogram, the instructions are further to cause the access control device to send the first authentication cryptogram using an authenticated encryption (AENC) algorithm.

15. The at least one machine-readable medium of claim 12, wherein the determination includes a verification that the trusted credential issuer is in a stored list of trusted issuers, the list generated during a prior registration.

16. The at least one machine-readable medium of claim 12, wherein the first signature is generated using a device key of the access control device.

17. The at least one machine-readable medium of claim 12, wherein the second authentication cryptogram indicates the action, which replaces a default action.

18. The at least one machine-readable medium of claim 12, wherein the action includes opening a door.

19. An access control device comprising:
processing circuitry; and
memory, including instructions, which when executed by the processing circuitry, cause the processing circuitry to:
send a first ephemeral public key to a user device;
receive, from the user device, a second ephemeral public key responsive to the first ephemeral public key;
send, to the user device, a first authentication cryptogram including a first signature, a public key certificate, and a Credential Trust Information (CTI);
receive, from the user device, a second authentication cryptogram including a second signature, a public key of the user device, and a credential;
authenticate the user device based on the credential and the second signature;
validate whether the user device is authorized to activate an action based on a determination of whether the credential received in the second authentication cryptogram is signed by a trusted credential issuer; and
cause, in response to validating that the user device is authorized to activate the action and that the user device is authenticated, the action to be performed.

20. The access control device of claim 19, wherein the CTI includes a sorted list with a plurality of hashes, and wherein the credential is a first hash from a user device list of hashes that matches a hash of the sorted list.
